(19) United States
(12) Patent Application Publication
(10) Pub. No.: US 2018/0100738 A1
(43) Pub. Date: Apr. 12, 2018

(54) LASER RADAR SYSTEM

(71) Applicants: Hoshibumi Ichiyanagi, Aichi (JP); Hidenori Miyazaki, Aichi (JP); Akira Mannami, Aichi (JP); Naoki Otani, Aichi (JP)

(72) Inventors: Hoshibumi Ichiyanagi, Aichi (JP); Hidenori Miyazaki, Aichi (JP); Akira Mannami, Aichi (JP); Naoki Otani, Aichi (JP)

(73) Assignee: OMRON AUTOMOTIVE ELECTRONICS CO., LTD., Aichi (JP)

(21) Appl. No.: 15/720,509

(22) Filed: Sep. 29, 2017

(30) Foreign Application Priority Data
Oct. 6, 2016 (JP) 2016-198289

(51) Int. Cl. G01C 3/22; G01C 3/02; G01S 17/48

(52) U.S. Cl. CPC G01C 3/22; G01S 17/48; G01C 3/02

(57) ABSTRACT

A laser radar system is installed in a moving body and includes a plurality of scanning type laser radar devices which detect distances to an object. The scanning type laser radar device has a first direction and a second direction in a scanning range. In the first direction, a detectable distance to an object having identical reflectance is longer. In the second direction, a detectable distance to an object having identical reflectance is shorter. The scanning range of one scanning type laser radar device overlaps with the scanning range of another scanning type laser radar device adjacent to the one scanning type laser radar device such that the detectable area in the first direction of the one scanning type laser radar device overlaps with the detectable area in the second direction of the other scanning type laser radar device.

### CROSS-REFERENCE TO RELATED APPLICATION

This application is based on Japanese Patent Application No. 2016-198289 filed with the Japan Patent Office on Oct. 6, 2016, the entire contents of which are incorporated herein by reference.

### FIELD

The disclosure relates to a laser radar system, and in particular to a laser radar system for monitoring a periphery of a moving body such as a vehicle or a ship.

### BACKGROUND

Conventionally, there has been a known technique of including a plurality of laser radar devices and detecting a person or an object existing around or approaching a moving body such as a vehicle. For example, JP 2008-224614 A discloses an object detection method that does not require control by a controller and can also save resources. In this object detection method, radar devices each including a light emitter and a light receiver are disposed on the right and left at the front of a vehicle. After the light receiver of the radar device on the right receives reflected light of laser light emitted by the light emitter of the radar device on the left, the light emitter of the radar device on the right emits laser light. After the light receiver of the radar device on the left receives reflected wave of the laser light emitted by the light emitter of the radar device on the right, the light emitter of the radar device on the left emits laser light.

In addition, JP 2014-052274 A discloses an object detection device that prevents erroneous detection of an object. This object detection device causes each of a plurality of laser radar devices disposed on a vehicle to emit pulses of laser light such that timings at which adjacent laser radar devices scan an overlapped area match. For example, a certain laser radar device scans a scanning range in a direction opposite to the scanning direction of another laser radar device such that a timing at which the certain laser radar device scans the overlapped area matches a timing at which the other laser radar device scans the overlapped area. Then, based on measurement results obtained by the adjacent laser radar devices, the object detection device detects an object existing in the overlapped area between the adjacent laser radar devices.

In addition, JP 2016-014665 A discloses a multi LADAR sensor system capable of operating in a dense environment. In this multi LADAR sensor system, a wavelength of operation is assigned to each LADAR sensor, and an optical receive filter blocks light transmitted at other wavelengths. A pulse width selected from a list is also assigned to each LADAR sensor. Each LADAR sensor uses a pulse width discriminator circuit to separate a pulse of interest from clutter of another transmitter. Higher level coding including a pulse sequence and code sequence correlation is implemented in a code division multiplexed (CDM) system.

In addition, JP H06-242224 A discloses an on-vehicle obstacle detection device that can surely detect obstacles in the vicinity of both sides of a vehicle even when the on-vehicle obstacle detection device is mounted on a lateral side of the vehicle front. In this on-vehicle obstacle detection device, a light source is disposed parallel to a traveling direction, and a symmetrical lens is disposed perpendicular to the traveling direction on the light path of the light source. Further, a light source is disposed at a predetermined angle with respect to the traveling direction, and a wide-angle lens is tilted by a predetermined angle and disposed on the light path of this light source. The wide-angle lens is cut so as to emit a strong laser beam to the left and a weak laser beam to the right. Then, the laser beams emitted from the light source are emitted asymmetrically with respect to the traveling direction.

In addition, JP H06-294870 A discloses an on-vehicle laser radar device that can almost eliminate blind spots in a detection area on a short distance side. This on-vehicle laser radar device includes at least two laser radar units. Light emitters of the laser radar units are disposed on the right and left sides of a vehicle. The light emitters are separated from each other by a distance not less than ½ of the vehicle width. Then, laser light is emitted forward from each light emitter, and a light receiver receives reflected light from a preceding vehicle to detect the distance to the preceding vehicle. At that time, the units operate in sync with each other.

JP H08-320992 A discloses a vehicle equipped with an optical scanning device for noncontact scanning of a road area on one side. The optical scanning device has functions of doze warning, automatic lane keeping, obstacle recognition, and the like. In this vehicle, the optical scanning device includes a plurality of infrared transmitting elements arranged in parallel to each other, and one associated CCD array. The optical scanning device is equipped with a connection evaluating unit for elapsed time measurement, in order to perform contrast measurement and contour recognition.

In addition, JP H10-111360 A discloses an inter-vehicle distance measuring device whose measurement reliability is improved by preventing mutual interference of measurement waves. This inter-vehicle distance measuring device includes a transmitting and receiving unit which projects a measurement wave in a traveling direction of a vehicle and receives a reflected wave of the measurement wave from a vehicle ahead, and an inter-vehicle distance calculation unit which calculates the distance to the vehicle ahead, according to a time period from when the transmitting and receiving unit transmits a measurement wave until the transmitting and receiving unit receives the measurement wave. In addition, the inter-vehicle distance measuring device is provided with a traveling azimuth detection unit which detects the traveling azimuth of the vehicle. The transmitting and receiving unit has a wavelength changing function and a selective reception function. The wavelength changing function sets a wavelength of a measurement wave to a different value when the traveling azimuth of the vehicle is in one azimuth and when the traveling azimuth is in a direction approximately opposite to the one azimuth, according to output from the traveling azimuth detection unit. The selective reception function receives only reflected waves having a wavelength approximately identical to the wavelength of a transmitted measurement wave.

In addition, JP 2014-052366 A discloses an optical measuring device with improved angular resolution in the vicinity of the optical measuring device. This optical measuring device includes a light source and an optical element which collects light beams emitted from the light source. The optical measuring device further includes a light irradiation unit which irradiates an object with a light beam, and a photodetector which detects via an imaging unit reflected light or scattered light of the light beam emitted to the object, the reflected light or scattered light being reflected or scattered by the object. The light path length from the light source to a conjugate image of the light source formed by the optical element differs at least in a first direction from the light path length from the photodetector to the conjugate image of the photodetector formed by the imaging unit.

In addition, JP 2015-215318 A discloses a laser radar device that takes into consideration a change in light acting as noise light. This laser radar device has N pairs of light sources and filters, a switch for switching the N pairs of light sources and filters, and M light receiving elements for distance measurement. Each of the pairs of light sources and filters has one laser light source and one light receiving filter. The laser light sources have emission wavelengths different from each other. Each of the light receiving filters guides only laser light with a certain wavelength to one light receiving element for distance measurement. The certain wavelength is the emission wavelength of the laser light source paired with the light reception filter to form a pair of light source and filter or a wavelength in the wavelength region in the vicinity of the emission wavelength. The laser light forms a return laser light flux. A laser light source having an emission wavelength at which relative intensity in the spectrum of sunlight is 20% or less is used as one of the pairs of light sources and filters. A laser light source having an emission wavelength at which relative intensity in the spectrum of artificial light in a distance measurement environment is 40% or less is used as each of the pairs of light sources and filters other than the one pair of light source and filter.

### SUMMARY

In a scanning type laser radar device, due to structural restrictions of an optical system that emits a laser beam, detectable distances of an object may not be bilaterally symmetric about an emission location, and the detectable distances may vary depending on a scan angle. For example, even in a case of detecting a distance to an object by performing scanning to the right and left centering on the front, a far object may be detected in the left direction; however, an object separated by an identical distance may not be detected in the right direction.

However, in a moving body such as a vehicle or a ship, it is necessary to detect persons and objects around the moving body within detectable distances as identical as possible over the entire periphery.

In view of the foregoing, the disclosure provides a laser radar system including a plurality of scanning type laser radar devices. Even in a case where detectable distances are different in a scanning range due to a structure of an optical system of one scanning type laser radar device, detectable distances are as identical as possible in all directions in the laser radar system.

In order to solve the above problem, a laser radar system is provided. The laser radar system is installed in a moving body and includes a plurality of scanning type laser radar devices configured to detect distances to an object. The scanning type laser radar device has a first direction and a second direction in a scanning range. In the first direction, a detectable distance to an object having identical reflectance is longer. In the second direction, a detectable distance to an object having identical reflectance is shorter. The scanning range of one scanning type laser radar device overlaps with the scanning range of another scanning type laser radar device, the one scanning type laser radar device and the other scanning type laser radar device adjacent to each other, such that the detectable area in the first direction of the one scanning type laser radar device overlaps with the detectable area in the second direction of the other scanning type laser radar device.

According to this configuration, the scanning ranges overlap with each other such that the detectable area in the direction in which the detectable distance of the one scanning type laser radar devices is longer overlaps with the detectable area in the direction in which the detectable distance of the other scanning type laser radar device is shorter, the one and the other scanning type laser radar devices adjacent to each other. Therefore, such a laser radar system can be provided that even in a case where detectable distances in the scanning ranges are different due to the structure of the optical system in one scanning type laser radar device, detectable distances are as identical as possible in all directions in the laser radar system including the plurality of scanning type laser radar devices.

Further, in the laser radar system installed in a vehicle and scanning the periphery of the vehicle, the detectable area in the second direction of the other scanning type laser radar device may overlap with the detectable area in the first direction of the one scanning type laser radar device, in all of the plurality of scanning type laser radar devices.

According to this configuration, it is possible to detect objects within detectable distances as identical as possible over the entire periphery of the vehicle.

Further, the scanning type laser radar device may adopt a rotating mirror system.

According to this configuration, in the rotating mirror system, detectable distances are as identical as possible in all directions even though detectable distances are different in the scanning range due to the structure of the optical system.

According to one or more embodiments of the disclosure, a laser radar system including a plurality of scanning type laser radar devices can be provided. Even in a case where detectable distances are different in a scanning range due to a structure of an optical system of one scanning type laser radar device, detectable distances are as identical as possible in all directions in the laser radar system.

### BRIEF DESCRIPTION OF THE DRAWINGS

FIG. 1A is a top view, FIG. 1B is a front view, FIG. 1C is a perspective view, and FIG. 1D is a side view of a scanning type laser radar device according to one or more embodiments of the disclosure.

FIG. 2A is a top view, FIG. 2B is a front view, FIG. 2C is a perspective view viewed in an identical direction as in FIG. 1C, and FIG. 2D is a bottom view of the scanning type laser radar device according to one or more embodiments of the disclosure, when a cover and the like are removed.

FIG. 3 is a block diagram of the scanning type laser radar device according to one or more embodiments of the disclosure.

FIG. 4A is a schematic side view and FIG. 4B is a front schematic view of the scanning type laser radar device according to one or more embodiments of the disclosure.

FIG. 5A is a front schematic view in a case of projecting light in a second direction, FIG. 5B is a front schematic view in a case of projecting light in a first direction, FIG. 5C is a front schematic view in a case of receiving light from the second direction, and FIG. 5D is a front schematic view in a case of receiving light from the first direction, of the scanning type laser radar device according to one or more embodiments of the disclosure.

FIG. 6 is an explanatory diagram for explaining a detectable area of the scanning type laser radar device according to one or more embodiments of the disclosure.

FIG. 7 is an explanatory diagram illustrating a case where the laser radar system according to one or more embodiments of the disclosure is installed in a vehicle.

FIG. 8 is an explanatory diagram for explaining a detectable area of the laser radar system according to one or more embodiments of the disclosure.

### DETAILED DESCRIPTION

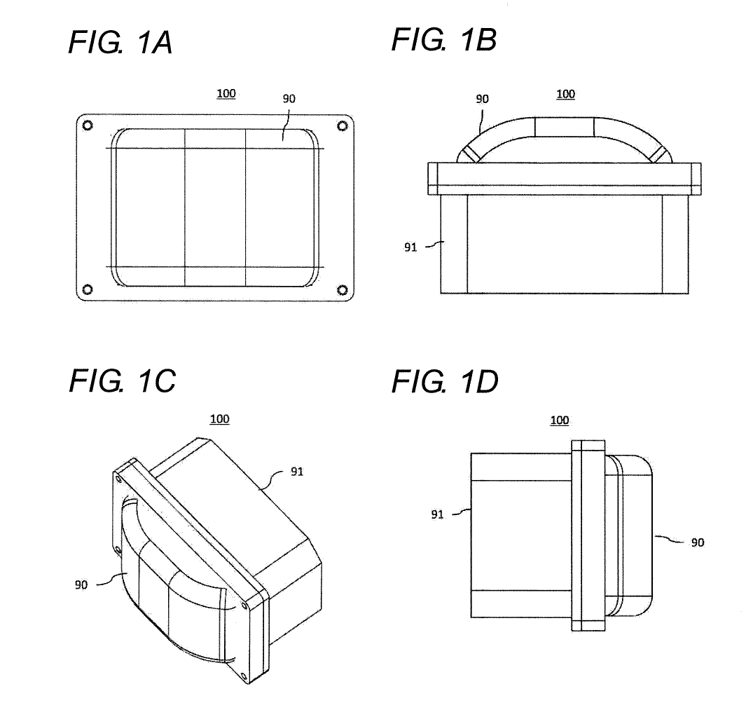

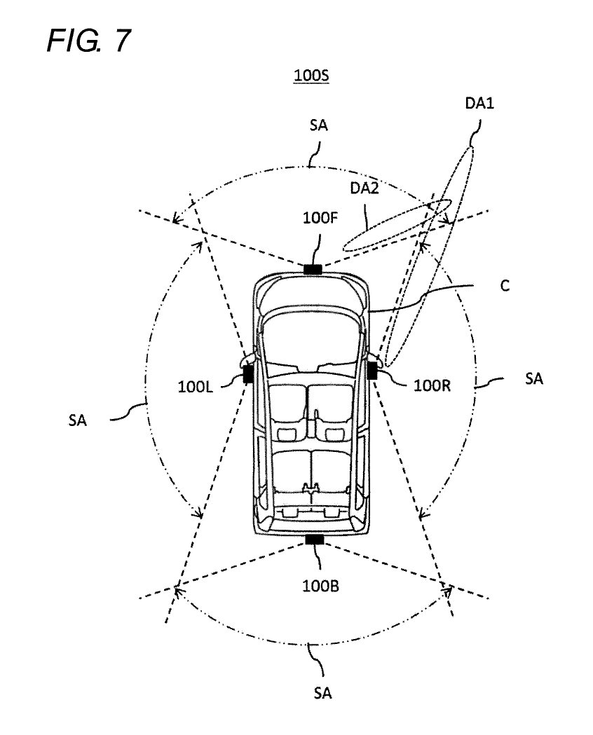

With reference to FIGS. 1A to 3, a scanning type laser radar device 100 of a laser radar system 100S (illustrated in FIG. 7) in one or more embodiments of the disclosure will be described. A plurality of scanning type laser radar devices 100 are installed in a moving body and detect distances to an object OBJ. In this specification, a vehicle (car, train, motorcycle, or the like) moving on the ground will be described as an example of a moving body; however, the moving body may be a ship moving on water or a flight vehicle moving in the air.

The scanning type laser radar device 100 measures a distance and a direction to an object to be measured based on a time difference between when the scanning type laser radar device 100 emits laser light and when the scanning type laser radar device 100 receives the reflected light, and a projection direction of the emitted laser light. Laser light is light with excellent directivity and convergence. A scanning direction is a direction in which scanning with laser light is performed. In one or more embodiments of the disclosure, as will be described later, in a laser diode array, laser diodes which emit light are arranged one-dimensionally, and in a photodiode array, photodiodes which receive light are arranged one-dimensionally. The light projection direction and the light reception direction are perpendicular to the arrangement direction of the laser diode array and the arrangement direction of the photodiode array in a one-dimensional direction. Thus, scanning of a plane (two-dimensional scanning) is performed by scanning once.

As illustrated in FIG. 1, the scanning type laser radar device 100 includes a laser radar cover 90 having an arch-shape in front view, a laser radar housing 91 having a substantially rectangular parallelepiped shape containing components such as laser diodes and photodiodes, which will be described later, inside. The laser radar cover 90 is made of a material that transmits laser light and the reflected light (electromagnetic wave). The laser radar cover 90 allows laser light emitted from the laser diode to be projected onto an object OBJ and the reflected light from the object OBJ to be received.

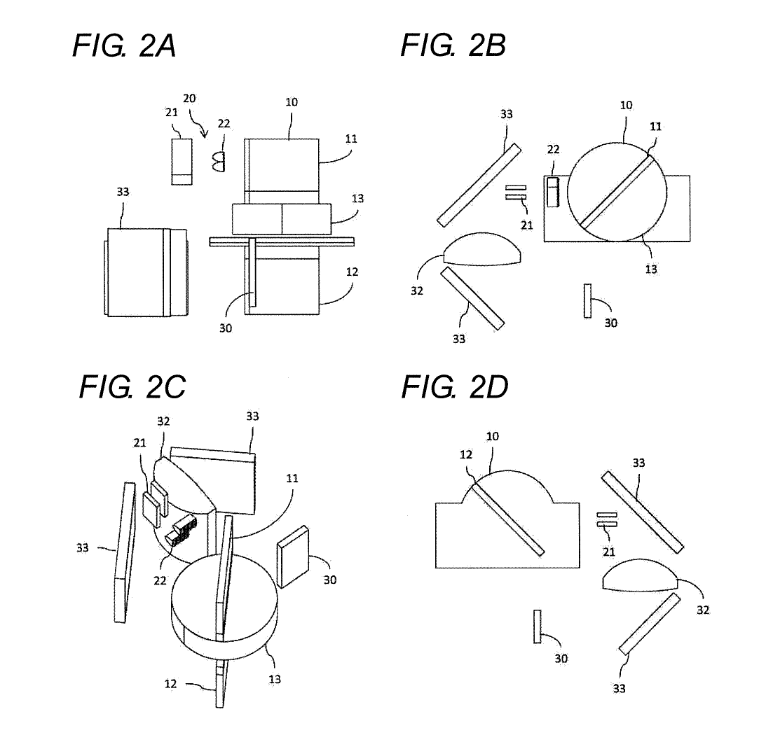

FIGS. 2A to 2D are views illustrating only main components contained inside by removing in the laser radar cover 90 and the laser radar housing 91. FIG. 2A is a top view, as viewed from the laser radar cover 90 having an arch-shape. The scanning type laser radar device 100 includes a laser diode module (LD module) 20 that emits laser light, a photodiode module (PD module) 30 that receives reflected light, and a rotating mirror 10 that projects laser light emitted from the laser diode module 20 while being rotated by a motor 13 and guides the reflected light to the photodiode module 30.

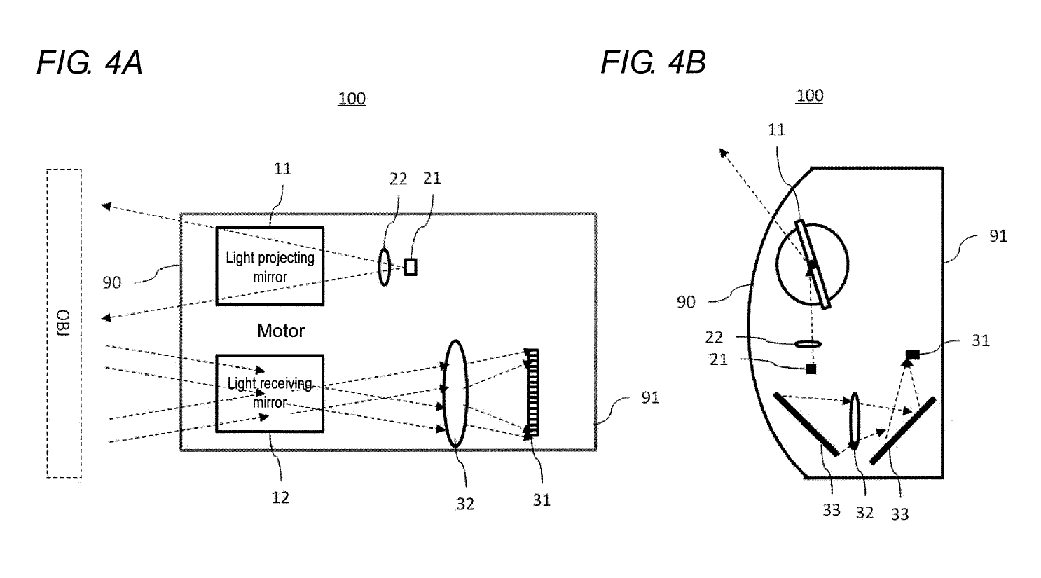

The laser diode module 20 includes a laser diode array 21 that actually emits laser light, and a collimator lens 22 that collimates emitted laser light. As illustrated in FIGS. 4A and 4B, the photodiode module 30 includes a photodiode array 31, two light receiving plates 33, and a light receiving lens 32. The photodiode array 31 actually receives reflected light of laser light and converts the reflected light into an electric signal. The light receiving plate 33 guides the reflected light to the photodiode array 31. The light receiving lens 32 is located on a light path of the reflected light and forms an image of the reflected light on the photodiode array 31. The rotating mirror 10 includes a light projecting mirror 11 and a light receiving mirror 12. The light projecting mirror 11 reflects laser light emitted from the laser diode module 20 and projects the laser light while rotating. The light receiving mirror 12 rotates coaxially with the light projecting mirror 11 and guides reflected light from an object to the photodiode module 30 while rotating. In this manner, a system of performing scanning by rotating a mirror to project laser light and to receive reflected light is called a rotating mirror system.

When the laser diode module 20 in an upper part of FIG. 2A emits laser light to the right in FIG. 2A, the laser light hits the light projecting mirror 11, and the rotating mirror 10 projects the laser light toward the front side of FIG. 2A (the side closer to the laser radar cover 90). Reflected light from the front side to the deep side in FIG. 2A hits the light receiving mirror 12 in the lower part of FIG. 2A, is reflected to the left in FIG. 2A, and is guided to the light receiving plate 33. With reference to FIG. 2B, laser light emitted to the right in FIG. 2B from the laser diode array 21 in the center of FIG. 2B is collimated by the collimator lens 22, reflected by the light projecting mirror 11, and is projected upward in FIG. 2B (toward the laser radar cover 90). With reference to FIG. 2D, reflected light coming from the top of FIG. 2D (from the laser radar cover 90) hits the light receiving mirror 12 and is reflected toward the light receiving plate 33 on the right of FIG. 2D, and then passes through the light receiving lens 32, and is received by the photodiode module 30.

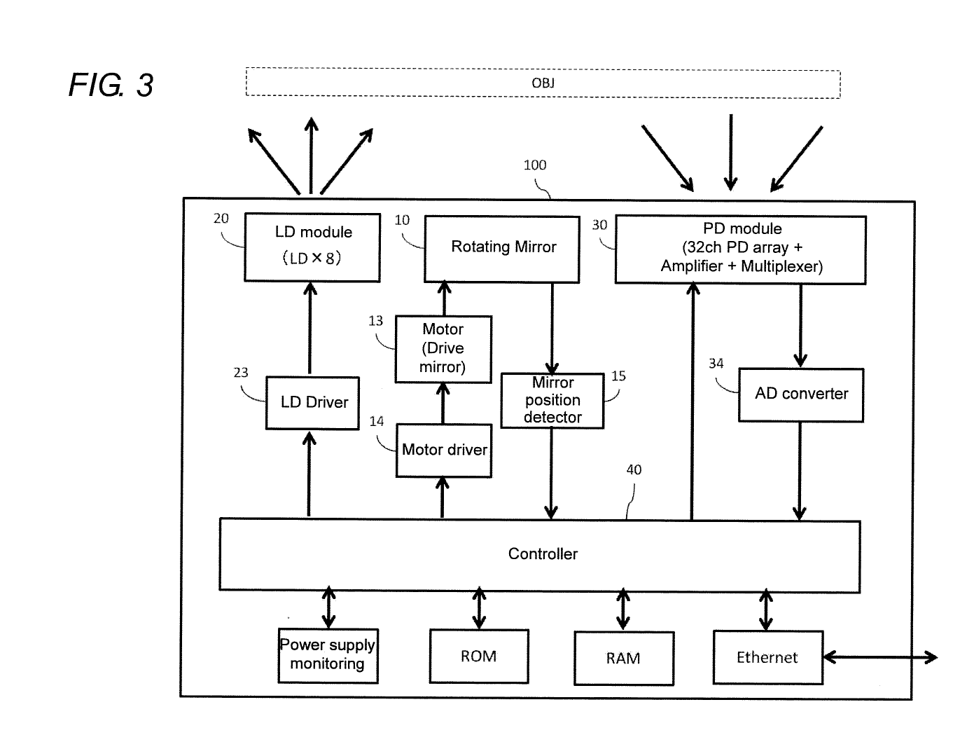

With reference to the block diagram of FIG. 3, the scanning type laser radar device 100 will be described in more detail. In addition to the laser diode module (LD module) 20, the photodiode module (PD module) 30 and the rotating mirror 10 described above, the scanning type laser radar device 100 further includes an LD driver 23, an AD converter 34, a motor driver 14, a mirror position detector 15, and a controller 40. The LD driver 23 drives light emission of the laser diode module 20. The AD converter 34 D converter converts an optical signal received by the photodiode module 30 into a digital signal. The motor driver 14 drives rotation of the motor 13 that rotates the rotating mirror 10. The mirror position detector 15 detects the position (rotation angle) of the mirror in the rotating mirror 10. The controller 40 controls the above constituents. The controller 40 is a microcomputer which controls a read only memory (ROM) that stores a control program or the like, a random access memory (RAM) which temporarily stores data such as a received signal and a mirror position, and Ethernet (registered trademark) of a network adapter for exchanging the above data and program with an external mechanism, power supply monitoring, and the like.

Note that the laser diode module 20 includes the laser diode array 21 composed of eight laser diodes. The eight laser diodes are disposed in a row in the laser diode array 21 in a direction perpendicular to a scanning direction. Further, the photodiode module 30 includes the photodiode array 31 composed of 32 photodiodes. Similarly, the 32 photodiodes are disposed in a row in the photodiode array 31 in a direction perpendicular to the scanning direction. As a result, it is possible to perform two-dimensional scanning by performing scanning once. However, the disclosure is not limited to this. Two-dimensional scanning may be performed by repeating one-dimensional scanning in multiple stages.

With reference to FIGS. 4A to 6, an area (detectable area) in which an object in a scanning range of the scanning type laser radar device 100 can be detected will be described. FIG. 4A is a schematic diagram illustrating a light projection method and a light reception method of the scanning type laser radar device 100. FIG. 4B is a schematic diagram illustrating an optical system of the scanning type laser radar device 100. Laser light emitted by a laser diode of a light emitting element included in the laser diode array 21 passes through the collimator lens 22, is reflected by the light projecting mirror 11, and is projected onto the object OBJ. Further, the reflected light reflected and returned by the object OBJ and returned is reflected by the light receiving mirror 12. The reflected light is further reflected by one of the light receiving plates 33 illustrated in FIG. 4B, passes through the light receiving lens 32, and is reflected by the other light receiving plate 33. Then, the photodiode in the photodiode array 31, which is a light receiving element, receives the reflected light. Thus, an image of the reflected light is formed on the photodiode.

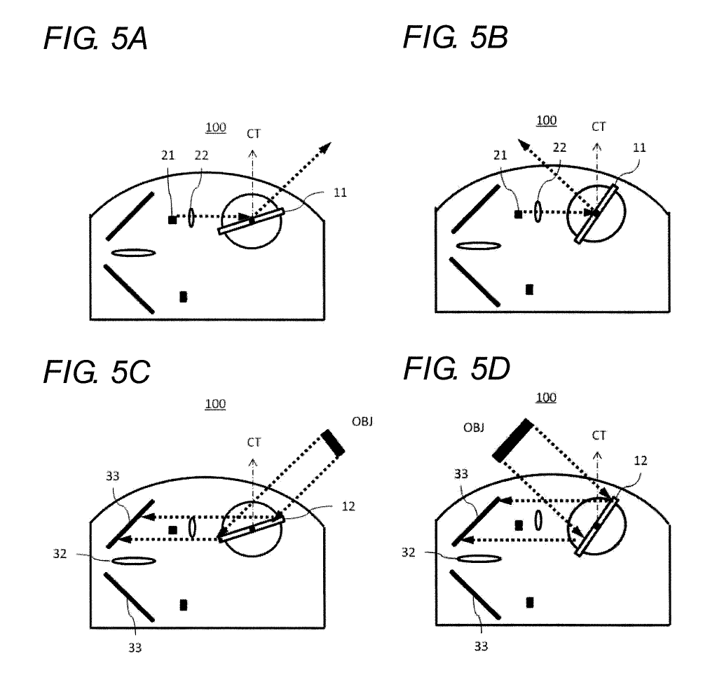

With reference to FIGS. 5A to 5D, light projection and light reception states in the scanning direction will be described. FIG. 5A illustrates the projection direction (+50°) which is separated outward by approximately 50° from a center direction CT in the range (scanning range) in which scanning is performed with laser light. That is, FIG. 5A illustrates the moment when the laser diode emits light and projects the light in +50° direction when the mirror position detector 15 detects that the light projecting mirror 11 is rotated by +50°. In addition, FIG. 5B illustrates the projection direction (−50°) separated inward by approximately 50° from the center direction CT in the scanning range. That is, FIG. 5B illustrates the moment when the laser diode emits light and projects the light in −50° direction when the mirror position detector 15 detects that the light projecting mirror 11 is rotated by −50°. Note that the scanning range in one or more embodiments of the disclosure is ±70° to both sides of the center direction CT, that is, the total scanning range is 140°. The disclosure is not limited to this, and the scanning range may be wider than this, for example, may be 160° in total. Then, for example, when the light projecting mirror 11 is rotated clockwise as viewed in FIGS. 5A and 5B, laser light is projected in the scanning range from −70° to +70°.

FIG. 5C illustrates a state where laser light projected when the light projecting mirror 11 is rotated by +50° is reflected by the object OBJ and returns to the light receiving mirror 12 which rotates coaxially with the light projecting mirror 11. Note that since time passes from light emission to light reception, the angle of the light projecting mirror 11 upon light projection and the angle of the light receiving mirror 12 upon light reception differ from each other in a strict sense. However, since the time difference is slight, the angles are illustrated as identical. In this case, an aperture area of the light receiving mirror 12 with respect to the object OBJ, which is the area where light from the object OBJ can be collected, is smaller because the angle formed by the object OBJ and the light receiving plate 33 with respect to the light receiving mirror 12 is larger.

FIG. 5D illustrates a state where laser light projected when the light projecting mirror 11 is rotated by −50° is reflected by the object OBJ and returns to the light receiving mirror 12 which rotates coaxially with the light projecting mirror 11. In this case, the aperture area of the light receiving mirror 12 with respect to the object OBJ is greater because the angle formed by the object OBJ and the light receiving plate 33 with respect to the light receiving mirror 12 is smaller. The fact that the aperture area varies with respect to the object OBJ means that sensitivity to the object OBJ varies. In the case of performing scanning with the rotating mirror 10 in the right-left direction (for example, horizontal direction) as viewed in FIG. 5D as in one or more embodiments of the disclosure, even if reflectance of the object OBJ is identical, a direction with good sensitivity and a direction with poor sensitivity exist in the scanning range structurally, depending on the angle formed by the object OBJ and the light reception path with respect to the rotating mirror 10. The so-called rotating mirror system has such restrictions due to the structure of the optical system.

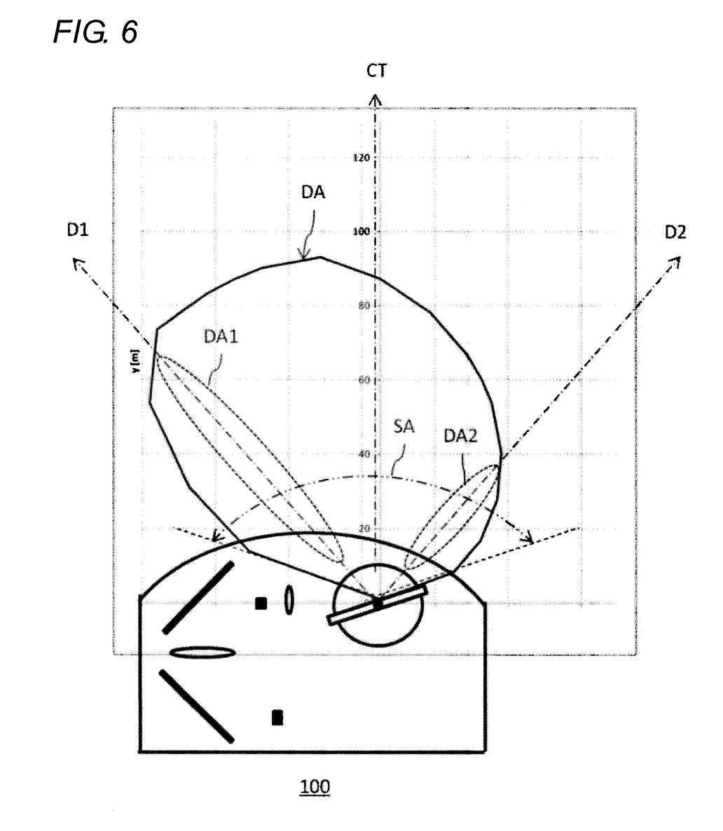

FIG. 6 illustrates a detectable area DA in the scanning type laser radar device 100. As described above, in the scanning type laser radar device 100, in a scanning range SA, a first direction D1 excellent in sensitivity and a second direction D2 poor in sensitivity exist on both sides of the center direction CT. In the first direction D1 excellent in sensitivity, a detectable distance becomes longer, and a detectable area DA1 in the first direction has an elliptical shape with a longer major axis. In contrast, in the second direction D2 poor in sensitivity, the detectable distance becomes shorter, and a detectable area DA2 in the second direction has an elliptical shape with a shorter major axis. Since the sensitivity of the light receiving element depends on the reflectance of the object OBJ, it is assumed that the reflectance is fixed, and the object OBJ is a standard object with, for example, reflectance of 10% with respect to emitted laser light.

The detectable distance changes continuously according to the rotation angle of the rotating mirror 10 within the scanning range SA. Therefore, if detectable areas at respective rotation angles are superimposed, the detectable area in the scanning type laser radar device 100 is the detectable area DA illustrated in FIG. 6. As described above, the scanning type laser radar device 100 has structural restrictions of the optical system. That is, in the scanning range SA, the first direction in which the detectable distance is longer and the second direction in which the detectable distance is shorter exist in the scanning direction, the first direction and the second direction existing on both sides of the center direction CT.

FIG. 7 illustrates a laser radar system 100S having the scanning type laser radar devices 100 provided in a vehicle C. The laser radar system 100S includes four scanning type laser radar devices 100. A scanning type laser radar device 100F which mainly scans a forward area is provided on a front of the vehicle C. A scanning type laser radar device 100B which mainly scans a backward area is provided on a back of the vehicle C. A scanning type laser radar device 100R which mainly scans an area to the right of the vehicle C is provided on the right side of the vehicle C. A scanning type laser radar device 100L which mainly scans an area to the left of the vehicle C is provided on the left side of the vehicle C.

The scanning range SA of one scanning type laser radar device 100 overlaps with the scanning range SA of another adjacent scanning type laser radar device 100. In one or more embodiments of the disclosure, the scanning type laser radar devices 100 are provided at four locations; however, the scanning type laser radar devices 100 may be provided, for example, at corners of the vehicle C in order to increase overlapped ranges. Further, in the laser radar system 100S, the adjacent scanning type laser radar devices 100 are disposed such that the scanning ranges SA overlap with each other in the following manner. The detectable area DA1 in the first direction of one of the adjacent scanning type laser radar devices 100 overlaps with the detectable area DA2 in the second direction of the other of the adjacent scanning type laser radar devices 100. For example, in the laser radar system 100S, the scanning type laser radar devices 100 are disposed such that the detectable area DA2 in the second direction of the scanning type laser radar device 100F which mainly scans the forward area overlaps with the detectable area DA1 in the first direction of the scanning type laser radar device 100R which mainly scans the area to the right of the vehicle C.

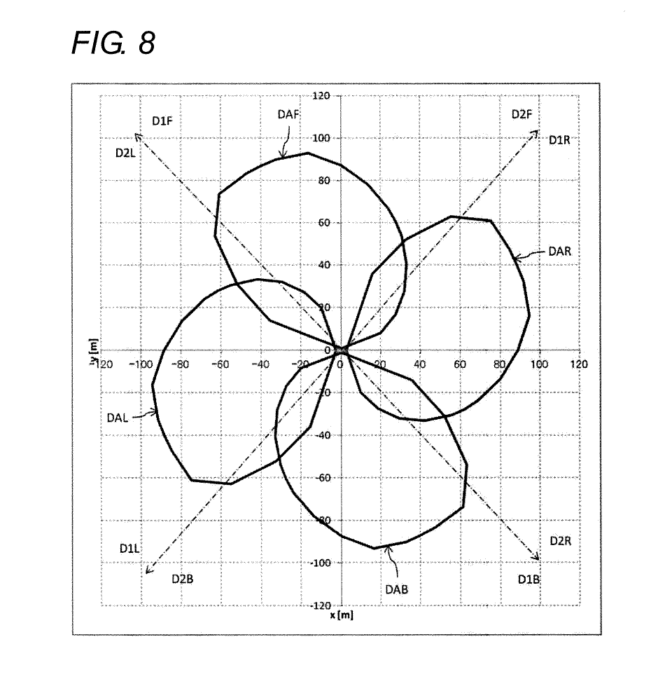

With reference to FIG. 8, the detectable area in the laser radar system 100S will be described. The laser radar system 100S includes the scanning type laser radar device 100F which scans a forward area, the scanning type laser radar device 100R which scans an area to the right of the vehicle C, the scanning type laser radar device 100B which scans a backward area, and the scanning type laser radar device 100L which scans an area to the left of the vehicle C. Therefore, as illustrated in FIG. 8, the laser radar system 100S has a detectable area extending in four directions from the origin (vehicle C). That is, the scanning type laser radar device 100F has a detectable area DAF, the scanning type laser radar device 100R has a detectable area DAR, the scanning type laser radar device 100B has a detectable area DAB, and the scanning type laser radar device 100L has a detectable area DAL.

Regarding the detectable area DAF, D1F represents the first direction in which the detectable distance of the scanning type laser radar device 100F is longer, and D2F represents the second direction in which the detectable distance of the scanning type laser radar device 100F is shorter. Regarding the detectable area DAR, D1R represents the first direction in which the detectable distance of the scanning type laser radar device 100R is longer, and D2R represents the second direction in which the detectable distance of the scanning type laser radar device 100R is shorter. Regarding the detectable area DAB, D1B represents the first direction in which the detectable distance of the scanning type laser radar device 100B is longer, and D2B represents the second direction in which the detectable distance of the scanning type laser radar device 100B is shorter. Regarding the detectable area DAL, D1L represents the first direction in which the detectable distance of the scanning type laser radar device 100L is longer, and D2L represents the second direction in which the detectable distance of the scanning type laser radar device 100L is shorter.

The scanning type laser radar device 100F and the scanning type laser radar device 100R are disposed such that the first direction D1R in which the detectable distance of the scanning type laser radar device 100R is longer overlaps with the second direction D2F in which the detectable distance of the scanning type laser radar device 100F adjacent to the scanning type laser radar device 100R is shorter. Similarly, the scanning type laser radar device 100R and the scanning type laser radar device 100B are disposed such that the first direction D1B in which the detectable distance of the scanning type laser radar device 100B is longer overlaps with the second direction D2R in which the detectable distance of the scanning type laser radar device 100R adjacent to the scanning type laser radar device 100B is shorter. Similarly, the scanning type laser radar device 100B and the scanning type laser radar device 100L are disposed such that the first direction D1L in which the detectable distance of the scanning type laser radar device 100L is longer overlaps with the second direction D2B in which the detectable distance of the scanning type laser radar device 100B adjacent to the scanning type laser radar device 100L is shorter. Similarly, the scanning type laser radar device 100L and the scanning type laser radar device 100F are disposed such that the first direction D1F in which the detectable distance of the scanning type laser radar device 100F is longer overlaps with the second direction D2L in which the detectable distance of the scanning type laser radar device 100L adjacent to the scanning type laser radar device 100F is shorter.

As described, scanning ranges of adjacent scanning type laser radar devices overlap with each other in the following manner. The detectable area in the direction in which the detectable distance of one of the adjacent scanning type laser radar devices is longer overlaps with the detectable area in the direction in which the detectable distance of the other scanning type laser radar device is shorter. Therefore, even in a case where detectable distances are different in the scanning range due to the structure of the optical system in one scanning type laser radar device, the detectable distances may be as identical as possible in all directions in the laser radar system 100S including the plurality of scanning type laser radar devices 100.

In the laser radar system 100S that scans the periphery of the vehicle C as in one or more embodiments of the disclosure, the detectable area DA2 in the second direction of each scanning type laser radar device 100 overlaps with the detectable area DA1 in the first direction of the scanning type laser radar device 100 adjacent to each scanning type laser radar device 100. Therefore, it is possible to detect objects within detectable distances as identical as possible over the entire periphery of the vehicle C. Even if the scanning type laser radar device 100 adopts the rotating mirror system, the detectable distances may be as identical as possible in all directions.

Note that the invention is not limited to the illustrated embodiment, and may be implemented with configurations within the scope not departing from the contents described in each item of the claims. While the invention has been mainly illustrated and described with reference to a particular embodiment, it will be apparent to those skilled in the art that various changes may be made in quantity and other detailed configurations of an illustrative embodiment without departing from the technical idea and the intended scope of the invention.

1. A laser radar system installed in a moving body and comprising a plurality of scanning type laser radar devices configured to detect distances to an object,
wherein each of the plurality of scanning type laser radar devices has a first direction in which a detectable distance to an object having identical reflectance is longer and a second direction in which a detectable distance to an object having identical reflectance is shorter, in a scanning range, and
wherein the scanning range of one of the plurality of scanning type laser radar devices overlaps with the scanning range of another of the plurality of scanning type laser radar devices, the one of the plurality of scanning type laser radar devices and the other of the plurality of scanning type laser radar devices adjacent to each other, such that a detectable area in the first direction of the one of the plurality of scanning type laser radar devices overlaps with a detectable area in the second direction of the other of the plurality of scanning type laser radar devices.

2. The laser radar system according to claim 1, the laser radar system installed in a vehicle and scanning a periphery of the vehicle,
wherein the detectable area in the second direction of the other of the plurality of scanning type laser radar devices overlaps with the detectable area in the first direction of the one of the plurality of scanning type laser radar devices, in all of the plurality of scanning type laser radar devices.

3. The laser radar system according to claim 1, wherein the scanning type laser radar device adopts a rotating mirror system.
